(19) United States
(12) Patent Application Publication
(10) Pub. No.: US 2015/0121503 A1
(43) Pub. Date: Apr. 30, 2015

(54) METHOD, SYSTEM AND STORAGE MEDIUM FOR USER ACCOUNT TO MAINTAIN LOGIN STATE

(71) Applicant: TENCENT TECHNOLOGY (SHENZHEN) COMPANY LIMITED, Shenzhen City (CN)

(72) Inventor: Pengfei XIONG, Shenzhen City (CN)

(73) Assignee: TENCENT TECHNOLOGY (SHENZHEN) COMPANY LIMITED, Shenzhen City (CN)

(21) Appl. No.: 14/589,504

(22) Filed: Jan. 5, 2015

Related U.S. Application Data
(63) Continuation of application No. PCT/CN2013/078615, filed on Jul. 1, 2013.

(30) Foreign Application Priority Data
Jul. 6, 2012 (CN) 201210233708.2

(51) Int. Cl. G06F 21/41

(52) U.S. Cl. CPC G06F 21/41
USPC 726/8

(57) ABSTRACT

Provided is a method for maintaining a login state of a user account, including: acquiring a data access request corresponding to a user ID, the data access request includes a session ID corresponding to the user ID; extracting the session ID from the data access request, and acquiring a session corresponding to the session ID; and allocating the session acquired to the data access request. Also provided are a system and a storage medium for a user account to maintain a login state. The aforementioned method, system and storage medium for a user account to maintain a login state can reduce resource overheads.

### RELATED APPLICATIONS

This application claims priority to PCT Patent Application No. PCT/CN2013/078615, entitled “METHOD AND SYSTEM FOR USER ACCOUNT TO MAINTAIN LOGIN STATE AND STORAGE MEDIUM”, filed on Jul. 1, 2013, which claims priority to Chinese Patent Application No. 201210233708.2, entitled “METHOD AND SYSTEM FOR USER ACCOUNT TO MAINTAIN LOGIN STATE”, filed on Jul. 6, 2012, both of which are incorporated by reference in their entirety.

### TECHNICAL FIELD

The present disclosure relates to the field of internet technology, and more particularly to a method, system and storage medium for a user account to maintain a login state.

### BACKGROUND ART

People's life-style has been changed along with the development of internet technology, and people's social activities, such as traditional visits, meetings and parties, have gradually evolved to online virtual social activities. Internet users can communicate and interact with each other through virtual communities such as forums, micro-blogs and online games, etc., and a user account represents a virtual identity of the user in a virtual community.

Usually, in a virtual community a user can have several virtual identities, namely several user accounts. The user can communicate and interact with others with different virtual identities by means of logging on the corresponding user accounts.

A conventional method for maintaining a login state of a user account generally adopts session mechanism to maintain the login state by means of allocating the session corresponding to the client to the data access request sent by the client itself. However, when the user switches user accounts at the client (namely changing the current operating user ID at the client), since the session corresponding to the user account can not be switched accordingly, the user has to logout the current user account having logged in, and then enters another user account and password to re-login, thereby creating a new session to maintain the login state. When there are a large number of users, frequent requests of login and logout may cause the login server costing a great quantity of resources to handle tasks such as querying account passwords, creating sessions and logging out sessions, etc., thereby increasing resource overheads. Moreover, each time of switching user account, the user is required to re-enter the user account and password to maintain login state, which makes the operation inconvenient.

### SUMMARY OF THE INVENTION

In view of the defects mentioned above, in one aspect, the present disclosure provides a method for maintaining a login state of a user account so as to reduce resource overheads.

A method for maintaining a login state of a user account, including:

acquiring a data access request corresponding to a user ID, the data access request includes a session ID corresponding to the user ID;

extracting the session ID from the data access request, and acquiring a session corresponding to the session ID; and

allocating the session acquired to the data access request.

In another aspect, the present disclosure further provides a system for a user account to maintain login state so as to reduce resource overheads, including:

an access request acquiring module, configured to acquire a data access request corresponding to a user ID, the data access request includes a session ID corresponding to the user ID;

a session acquiring module, configured to extract the session ID from the data access request, and acquire a session corresponding to the session ID; and

a session allocating module, configured to allocate the session acquired to the data access request.

In another aspect, the present disclosure further provides a storage medium to reduce resource overheads.

One or more non-transitory computer readable storage medium containing computer-executable instructions for performing a method for maintaining a login state of a user account, the method including:

acquiring a data access request corresponding to a user ID, the data access request includes a session ID corresponding to the user ID;

extracting the session ID from the data access request, and acquiring a session corresponding to the session ID; and

allocating the session acquired to the data access request.

According to the aforementioned method, system and storage medium, the data access request including the session ID corresponding to the user ID (the user account selected by the user) is acquired; then the session ID is extracted from the data access request and a session corresponding to the session ID is acquired; and the acquired session is allocated to the data access request. That is to say, the session allocated to the data access request corresponds to the user ID, and the session corresponding to the user ID can be used repeatedly, such that the function of multiple user accounts maintaining login state simultaneously at the same client can be realized without the need of re-authenticating the user ID and re-creating a new session allocated to the data access request corresponding to the user ID when switching user accounts. The present disclosure reduces the times needed for authenticating the user ID and reduces the loads from authenticating account passwords at the login server; in the meantime, since no new session is created for handling data access request, the frequency of creating and cleaning sessions is reduced, thereby reducing resource overheads.

With respect to the user, when switching user accounts, the user is not required to frequently enter the account and password for logging in, thereby simplifying the operation and improving the convenience of operation.

### BRIEF DESCRIPTION OF THE DRAWINGS

FIG. 1 is a flow diagram illustrating the method for maintaining a login state of a user account according to one embodiment of the present invention;

FIG. 2 is a flow diagram illustrating the method for maintaining a login state of a user account according to one embodiment of the present invention;

FIG. 3 is a structural diagram illustrating the system for a user account to maintain a login state according to one embodiment of the present invention;

FIG. 4 is a structural diagram illustrating the system for a user account to maintain a login state according to another embodiment of the present invention.

### PREFERRED EMBODIMENTS OF THE INVENTION

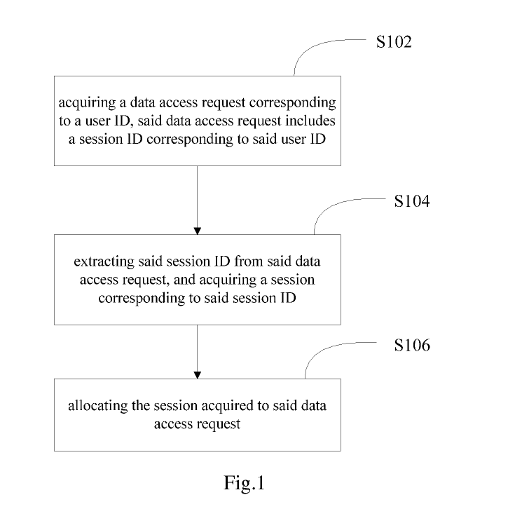

In one embodiment as shown in FIG. 1, the method for maintaining a login state of a user account includes:

S102, acquiring a data access request corresponding to a user ID, said data access request includes a session ID corresponding to said user ID.

A user ID refers to the ID of a user account, which may be a character string or numerals. In one embodiment, the data access request is sent from the client, and corresponds to the user ID in activated state. The user ID in activated state refers to the current user ID in operating state for the client, corresponding to the user account currently being operated at the client. In this embodiment, the client can acquire the input setting operations for the user ID, and set the user ID corresponding to the setting operations to be in activated state.

For example, the client may be a browser. The browser can display multiple user IDs on web pages in the form of a pull-down menu, and the user ID in selected state in the pull-down menu is the user ID in activated state. The user can execute a selecting operation on the pull-down menu to set the activated state of a user ID. The data access request sent through the browser to other websites by the user will correspond to the user ID in activated state on the web page.

In one embodiment, the session ID and the corresponding user ID can be cached in advance. In this embodiment, the client can search the session ID corresponding to the user ID in the cache, and generate the data access request according to the session ID having been found.

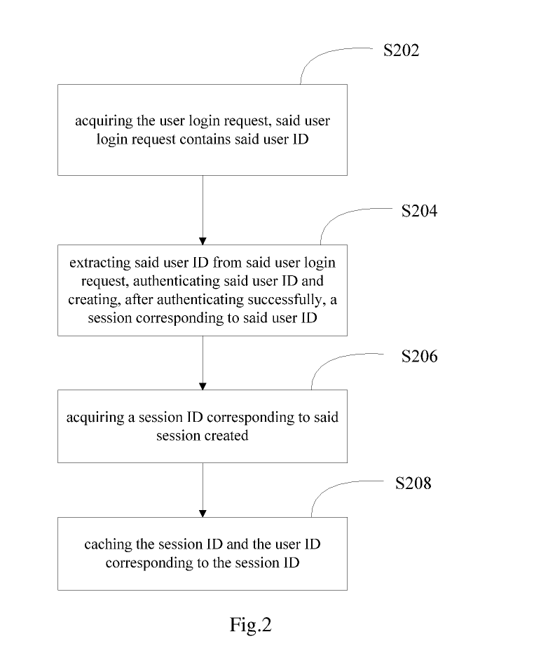

In one embodiment as shown in FIG. 2, the data access request is a user login request, and the method for maintaining a login state of a user account includes:

S202, acquiring the user login request, said user login request contains a user ID;

S204, extracting said user ID from said user login request, authenticating said user ID and creating, after authenticating successfully, a session corresponding to said user ID;

S206, acquiring a session ID corresponding to said session created; and

S208, caching the session ID and the user ID corresponding to the session ID.

In this embodiment, the user login request includes a password. The step of authenticating the user ID may be specified as authenticating the user ID by authenticating the password; while in another embodiment, the user ID may also be authenticated through LDAP (Lightweight Directory access Protocol).

In this embodiment, the step of caching the session ID and the user ID corresponding to the session ID can be specified as caching the session ID and the user ID corresponding to the session ID to a cookie and/or a paging file at the client.

In this embodiment, the client can search the session ID corresponding to the user ID in local cookies and/or paging files, and generate the data access request according to the session ID having been found.

For example, the user ID and session ID can be saved into cookies in the form of key-value pair. When the data access request is generated at the client, the user ID in activated state is acquired; the corresponding session ID is searched from the cookie according to the user ID, and appended to the head of the data access request.

Alternatively, the session ID and the corresponding user ID may be saved in the form of hidden tag (<hidden></hidden>) in paging files. When the data access request is generated at the client, the user ID in activated state is acquired; the corresponding session ID is searched from the hidden tag of the paging file according to the user ID, and appended to the end of the URL (Uniform Resource Locator) of the data access request. For example, the generated URL of the data access request may be “http://www.aaa.com/index.html?sid=123456789”, wherein, “http://www.aaa.com/index.html” is the original URL of the data access request, and “123456789” is the session ID.

S104, extracting said session ID from said data access request, and acquiring a session corresponding to said session ID.

Session IDs and sessions are corresponded one to one. In one embodiment, sessions, existing in the form of objects, are saved in a server's memory. The mapping relation between session IDs and session objects can be pre-defined; furthermore, the mapping relation can be cached through a key-value table. The step of acquiring a session corresponding to the session ID can be specified as: searching, according to the session ID, the session corresponding to the session ID from the key-value table.

Furthermore, the session object can be serialized into a binary stream for persistent storage. The step of acquiring a session corresponding to the session ID can be specified as: acquiring a persistently stored binary stream corresponding to said session ID, and de-serializing the acquired binary stream into a session object.

Since the memory capacity of the server is limited, when there are a large amount of visits, there will be more session objects, occupying a large amount of memory space of the server. By means of serializing the session object in the memory into the binary stream and persistently storing the binary stream, the session objects can be stored, in the form of files, into hard disks, magnetic tapes or saved into databases in the form of binary stream, thereby reducing memory occupation rate of the session object, and saving system resources.

S106, allocating the session acquired to the data access request.

Allocating the session acquired to the data access request means allocating the operating space and time, as expressed by the session, to the data access request, for the use in data interaction.

In one embodiment, the session can be capsulated into a session object, and the data access request having been received can be capsulated into an access request object. The step of allocating the session acquired to the data access request can be specified as: assigning the session object as an attribute to the access request object.

In one embodiment, the session further has a lifecycle. Whether the lifecycle of the session has expired can be periodically detected, and when the lifecycle of the session has expired, the session is logged out.

In this embodiment, after the step of acquiring a session corresponding to the session ID, the method further includes: prompting for login when said session corresponding to said session ID is not acquired.

A session corresponding to a user ID may be logged out due to expiry. After the session has been logged out, the corresponding session will not be acquired by searching according to the session ID. In this embodiment, a session corresponding to the user ID can be re-created by jumping to the prompting page to prompt the user to log in.

In one embodiment, the step of acquiring a session corresponding to the session ID is specified as: sending a session acquiring request to a trusted server, and the session acquiring request contains the session ID; and acquiring the session, which is sent back from the trusted server, corresponding to the session ID.

In this embodiment, the user's login is realized by means of single sign-on login, that is, the login user can visit all trusted servers without the need of logging in again. After extracting the session ID from the data access request having been received, the user can search the created session corresponding to the session ID on the trusted server having been logged in by means of sending a session acquiring request. The acquired session can be serialized into a binary stream and sent back by the trusted server. The binary stream having been sent back can be de-serialized into the session object.

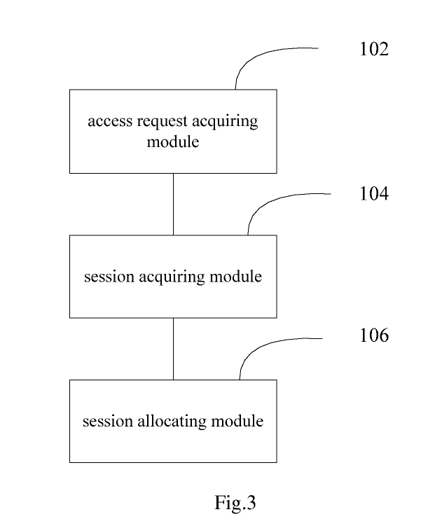

In one embodiment as shown in FIG. 3, a system for a user account to maintain a login state includes: an access request acquiring module 102, a session acquiring module 104, and a session allocating module 106, wherein:

The access request acquiring module 102 is configured to acquire a data access request corresponding to a user ID, the data access request includes a session ID corresponding to the user ID.

A user ID refers to the ID of a user account, which may be a character string or numerals. In one embodiment, the data access request acquired by the access acquiring module 102 is sent from the client, and corresponds to the user ID in activated state. The user ID in activated state refers to the current user ID in operating state for the client, corresponding to the user account currently being operated at the client. In this embodiment, the client can acquire the input setting operations for the user ID, and set the user ID corresponding to the setting operations to be in activated state.

For example, the client may be a browser. The browser can display multiple user IDs on web pages in the form of a pull-down menu, and the user ID in selected state in the pull-down menu is the user ID in activated state. The user can execute a selecting operation on the pull-down menu to set the activated state of a user ID. The data access request sent through the browser to other websites by the user will correspond to the user ID in activated state on the web page.

In one embodiment, the session ID and the corresponding user ID can be cached in advance. In this embodiment, the client can search the session ID corresponding to the user ID in the cache, and generate the data access request according to the session ID having been found.

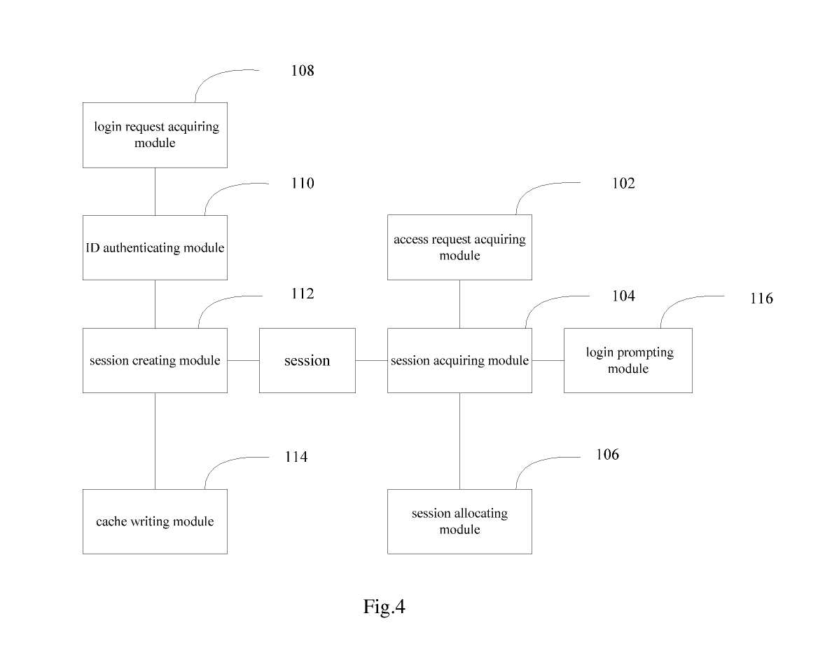

In one embodiment as shown in FIG. 4, the data access request is a user login request, and the system for a user account to maintain a login state includes:

a login request acquiring module 108, configured to acquire the user login request, the user login request contains a user ID;

an ID authenticating module 110, configured to extract the user ID from the user login request, and authenticate the user ID;

a session creating module 112, configured to create, after the user ID is successfully authenticated, a session corresponding to the user ID; and

a cache writing module 114, configured to acquire a session ID corresponding to the session created, and cache the session ID and the user ID corresponding to the session ID.

In this embodiment, the user login request includes a password. The ID authenticating module 110 can be configured to authenticate the user ID by authenticating the password. In another embodiment, the ID authenticating module 110 may be configured to authenticate the user ID through LDAP (Lightweight Directory access Protocol).

In this embodiment, the cache writing module 114 can be further configured to cache the session ID and the user ID corresponding to the session ID to a cookie and/or a paging file at the client.

In this embodiment, the client can search the session ID corresponding to the user ID in local cookies and/or paging files, and generate the data access request according to the session ID having been found.

For example, the cache writing module 114 can be configured to save the user ID and session ID into cookies in the form of key-value pair. When the data access request is generated at the client, the user ID in activated state is acquired; the corresponding session ID is searched from the cookie according to the user ID, and appended to the head of the data access request.

Alternatively, the cache writing module 114 may be configured to save the session ID and the corresponding user ID in the form of hidden tag (<hidden></hidden>) in paging files. When the data access request is generated at the client, the user ID in activated state is acquired; the corresponding session ID is searched from the hidden tag of the paging file according to the user ID, and appended to the end of the URL (Uniform Resource Locator) of the data access request. For example, the generated URL of the data access request may be “http://www.aaa.com/index.html?sid=123456789”, wherein, “http://www.aaa.com/index.html” is the original URL of the data access request, and “123456789” is the session ID.

The session acquiring module 104 is configured to extract the session ID from the data access request, and acquire a session corresponding to the session ID.

Session IDs and sessions are corresponded one to one. In one embodiment, sessions, existing in the form of objects, are saved in a server's memory. The mapping relation between session IDs and session objects can be pre-defined; furthermore, the mapping relation can be cached through a key-value table. The session acquiring module 104 can further be configured to search, according to the session ID, the session corresponding to the session ID from the key-value table.

Furthermore, the session object can be serialized into a binary stream for persistent storage. The session acquiring module 104 can further be configured to acquire a persistently stored binary stream corresponding to said session ID, and de-serialize the acquired binary stream into a session object.

Since the memory capacity of the server is limited, when there are a large amount of visits, there will be more session objects, occupying a large amount of memory space of the server. By means of serializing the session object in the memory into the binary stream and persistently storing the binary stream, the session objects can be stored, in the form of files, into hard disks, magnetic tapes or saved into databases in the form of binary stream, thereby reducing memory occupation rate of the session object, and saving system resources.

The session allocating module 106 is configured to allocate the session acquired to the data access request.

Allocating the session acquired to the data access request means allocating the operating space and time, as expressed by the session, to the data access request, for the use in data interaction.

In one embodiment, the session can be capsulated into a session object, and the data access request having been received can be capsulated into an access request object. The session allocating module 106 can be configured to assign the session object as an attribute to the access request object.

In one embodiment, the session further has a lifecycle. The system for a user account to maintain a login state further includes a session detecting module (not shown in figures) configured to periodically detect whether the lifecycle of the session has expired, and log out the session when the lifecycle of the session has expired.

In this embodiment as shown in FIG. 4, the system for a user account to maintain a login state further includes a login prompting module 116 configured to prompt for login when the session corresponding to the session ID is not acquired.

A session corresponding to a user ID may be logged out due to expiry. After the session has been logged out, the corresponding session will not be acquired by searching according to the session ID. In this embodiment, the login prompting module 116 can prompt the user to log in by means of jumping to the prompting page, thereby re-creating a session corresponding to the user ID.

In one embodiment, the session acquiring module 104 is further configured to send a session acquiring request to a trusted server, and the session acquiring request contains the session ID; and acquire the session, which is sent back from the trusted server, corresponding to the session ID.

In this embodiment, the user's login is realized by means of single sign-on login, that is, the login user can visit all trusted servers without the need of logging in again. Having extracted the session ID from the data access request received, the session acquiring module 104 can search the created session corresponding to the session ID on the trusted server having been logged in by the user by means of sending a session acquiring request. The acquired session can be serialized into a binary stream and sent back by the trusted server. The session acquiring module 104 can de-serialize the binary stream sent back into the session object.

The present disclosure further provides one or more non-transitory computer readable storage medium containing computer-executable instructions for performing a method for maintaining a login state of a user account. It should be understood by those skilled in the art that all or part of the processes of preferred embodiments disclosed above may be realized through relevant hardware commanded by computer program instructions. Said program may be saved in a computer readable storage medium, and said program may include the processes of the preferred embodiments mentioned above when it is executed. Wherein, said storage medium may be a diskette, optical disk, ROM (Read-Only Memory) or RAM (Random Access Memory), and so on.

According to the aforementioned method, system and storage medium, the data access request including the session ID corresponding to the user ID (the user account selected by the user) is acquired; then the session ID is extracted from the data access request and a session corresponding to the session ID is acquired; and the acquired session is allocated to the data access request. That is to say, the session allocated to the data access request corresponds to the user ID, and the session corresponding to the user ID can be used repeatedly, such that the function of multiple user accounts maintaining login state simultaneously at the same client can be realized without the need of re-authenticating the user ID and re-creating a new session allocated to the data access request corresponding to the user ID when switching user accounts. The present disclosure reduces the times needed for authenticating the user ID and reduces the loads from authenticating account passwords at the login server; in the meantime, since no new session is created for handling data access request, the frequency of creating and cleaning sessions is reduced, thereby reducing resource overheads.

With respect to the user, when switching user accounts, the user is not required to frequently enter the account and password for logging in, thereby simplifying the operation and improving the convenience of operation.

While various embodiments are discussed therein specifically, it will be understood that they are not intended to limit to these embodiments. It should be understood by those skilled in the art that various modifications and replacements may be made therein without departing from the theory of the present disclosure, which should also be seen in the scope of the present disclosure. The scope of the present disclosure should be defined by the appended claims.

What is claimed is:

1. A method for maintaining a login state of a user account, comprising following steps:
acquiring a data access request corresponding to a user ID, said data access request includes a session ID corresponding to said user ID;
extracting said session ID from said data access request, and acquiring a session corresponding to said session ID; and
allocating the session acquired to said data access request.

2. The method for maintaining a login state of a user account according to claim 1, wherein said data access request is a user login request, and said method comprises following steps:
acquiring the user login request, said user login request contains said user ID;
extracting said user ID from said user login request, authenticating said user ID and creating, after authenticating successfully, a session corresponding to said user ID;
acquiring a session ID corresponding to said session created; and
caching the session ID and the user ID corresponding to the session ID.

3. The method for maintaining a login state of a user account according to claim 2, wherein, said step of caching the session ID and the user ID corresponding to the session ID comprises:
caching said session ID and said user ID corresponding to said session ID to a cookie and/or a paging file at a client.

4. The method for maintaining a login state of a user account according to claim 2, wherein, said step of caching the session ID and the user ID corresponding to the session ID comprises:
saving said session ID and said user ID corresponding to said session ID in a paging file in form of hidden tag.

5. The method for maintaining a login state of a user account according to claim 1, wherein, said step of acquiring a session corresponding to said session ID comprises:
sending a session acquiring request to a trusted server, said session acquiring request contains said session ID; and
acquiring a session, which is sent back from said trusted server, corresponding to said session ID.

6. The method for maintaining a login state of a user account according to claim 1, wherein, after said step of acquiring a session corresponding to said session ID, said method further comprises:
prompting for login when said session corresponding to said session ID is not acquired.

7. The method for maintaining a login state of a user account according to claim 1, wherein, said session exists in form of a session object; said method further comprise:
serializing said session object into a binary stream for persistent storage; and
said step of acquiring a session corresponding to said session ID comprises: acquiring a persistently stored binary stream corresponding to said session ID, and de-serializing the acquired binary stream into a session object.

8. The method for maintaining a login state of a user account according to claim 1, further comprising:
periodically detecting whether a lifecycle of said session has expired, and logging out said session when the lifecycle of said session has expired.

9. A system for a user account to maintain a login state, comprising:
an access request acquiring module, configured to acquire a data access request corresponding to a user ID, said data access request includes a session ID corresponding to the user ID;
a session acquiring module, configured to extract said session ID from said data access request, and acquire a session corresponding to said session ID; and
a session allocating module, configured to allocate the session acquired to said data access request.

10. The system for a user account to maintain a login state according to claim 9, wherein the data access request is a user login request, and said system comprises:
a login request acquiring module, configured to acquire the user login request, said user login request contains said user ID;
an ID authenticating module, configured to extract said user ID from said user login request, and authenticate said user ID;
a session creating module, configured to create, after the user ID is successfully authenticated, a session corresponding to said user ID; and
a cache writing module, configured to acquire a session ID corresponding to said session created, and cache said session ID and said user ID corresponding to said session ID.

11. The system for a user account to maintain a login state according to claim 10, wherein, said cache writing module is further configured to cache said session ID and said user ID corresponding to said session ID to a cookie and/or a paging file at a client.

12. The system for a user account to maintain a login state according to claim 9, wherein, said cache writing module is further configured to save said session ID and said user ID corresponding to said session ID in a paging file in form of hidden tag.

13. The system for a user account to maintain a login state according to claim 9, wherein, said session acquiring module is further configured to send a session acquiring request containing said session ID to a trusted server, and acquire a session, which is sent back from said trusted server, corresponding to said session ID.

14. The system for a user account to maintain a login state according to claim 9, further comprising:
a login prompting module, configured to prompt for login when said session corresponding to said session ID is not acquired.

15. The system for a user account to maintain a login state according to claim 9, wherein, said session exists in form of a session object; said session acquiring module is further configured to serialize said session object into a binary stream for persistent storage; acquire a persistently stored binary stream corresponding to said session ID, and de-serialize the binary stream acquired into a session object.

16. The system for a user account to maintain a login state according to claim 9, further comprising:
a session detecting module, configured to periodically detect whether a lifecycle of said session has expired, and log out said session when the lifecycle of said session has expired.

17. One or more non-transitory computer readable storage medium containing computer-executable instructions for performing a method for maintaining a login state of a user account, wherein, said method comprises following steps:
acquiring a data access request corresponding to a user ID, said data access request includes a session ID corresponding to the user ID;
extracting said session ID from said data access request, and acquiring a session corresponding to said session ID; and
allocating the session acquired to said data access request.

18. The storage medium according to claim 17, wherein, said data access request is a user login request, and said method comprises following steps:
acquiring the user login request, said user login request contains said user ID;
extracting said user ID from said user login request, authenticating said user ID and creating, after authenticating successfully, a session corresponding to said user ID;
acquiring a session ID corresponding to said session created; and
caching the session ID and the user ID corresponding to the session ID.

19. The storage medium according to claim 18, wherein, said step of caching the session ID and the user ID corresponding to the session ID comprises:
caching said session ID and said user ID corresponding to said session ID to a cookie and/or a paging file at a client.

20. The storage medium according to claim 18, wherein, said step of caching said session ID and said user ID corresponding to said session ID further comprises:
saving said session ID and said user ID corresponding to said session ID in a paging file in form of hidden tag.
